(19) United States
(12) Patent Application Publication
(10) Pub. No.: US 2025/0039929 A1
(43) Pub. Date: Jan. 30, 2025

(54) CHANNEL TRANSMISSION METHOD AND APPARATUS AND TERMINAL

(71) Applicant: VIVO MOBILE COMMUNICATION CO., LTD., Guangdong (CN)

(72) Inventor: Lei JIANG, Guangdong (CN)

(73) Assignee: VIVO MOBILE COMMUNICATION CO., LTD., Guangdong (CN)

(21) Appl. No.: 18/913,374

(22) Filed: Oct. 11, 2024

Related U.S. Application Data
(63) Continuation of application No. PCT/CN2023/087587, filed on Apr. 11, 2023.

(30) Foreign Application Priority Data
Apr. 12, 2022 (CN) 202210384076.3

(51) Int. Cl. H04W 74/0808; H04W 72/0453; H04W 72/51; H04W 74/00

(52) U.S. Cl. CPC H04W 74/0808; H04W 72/0453; H04W 72/51; H04W 74/002

(57) ABSTRACT

A channel transmission method and apparatus and a terminal. The channel transmission method in embodiments of this application includes: obtaining resource information for sidelink transmission on an unlicensed band; and performing the sidelink transmission by using a first mode based on the resource information. The first mode includes at least one of the following: performing the sidelink transmission on multiple sidelink transmission resources, where a first signal is filled between two of the multiple sidelink transmission resources, such that a gap between the two sidelink transmission resources is less than or equal to a first time threshold; accessing a channel using Type 1 LBT with the highest channel access priority class or Type 2A LBT, and performing PSFCH transmission; and determining a channel occupancy time COT initiated by a second terminal, and performing the sidelink transmission by sharing the COT initiated by the second terminal.

### CROSS-REFERENCE TO RELATED APPLICATIONS

This application is a continuation of International Application No. PCT/CN2023/087587 filed on Apr. 11, 2023, which claims priority to Chinese Patent Application No. 202210384076.3 filed on Apr. 12, 2022, which are incorporated herein by reference in their entireties.

### TECHNICAL FIELD

This application pertains to the field of communication technologies, and specifically, relates to a channel transmission method and apparatus and a terminal.

### BACKGROUND

In the sidelink channel structure of the related art, there must be one gap whose length is a symbol after each transmission, with the gap being greater than 16 microseconds (us). Therefore, different sidelink transmissions cannot be considered as a transmission burst, and each transmission requires the terminal to perform channel listening again to obtain the channel occupancy time, which severely reduces the transmission efficiency.

### SUMMARY

Embodiments of this application provide a channel transmission method and apparatus and a terminal.

According to a first aspect, a channel transmission method is provided, including:
obtaining, by a first terminal, resource information for sidelink transmission on an unlicensed band; and
performing the sidelink transmission by using a first mode based on the resource information; where the first mode includes at least one of the following:
performing the sidelink transmission on multiple sidelink transmission resources, where a first signal is filled between two of the multiple sidelink transmission resources, such that a gap between the two sidelink transmission resources is less than or equal to a first time threshold;
accessing a channel using Type 1 listen before talk LBT with the highest channel access priority class or Type 2A LBT, and performing physical sidelink feedback channel PSFCH transmission; and
determining a channel occupancy time COT initiated by a second terminal, and performing the sidelink transmission by sharing the COT initiated by the second terminal; where
the sidelink transmission resource includes at least one of the following: a physical sidelink shared channel PSSCH, a PSFCH, a physical sidelink control channel PSCCH, and an automatic gain control AGC symbol.

According to a second aspect, a channel transmission apparatus is provided, including:
an obtaining module configured to obtain resource information for sidelink transmission on an unlicensed band; and
a processing module configured to perform the sidelink transmission by using a first mode based on the resource information; where the first mode includes at least one of the following:
performing the sidelink transmission on multiple sidelink transmission resources, where a first signal is filled between two of the multiple sidelink transmission resources, such that a gap between the two sidelink transmission resources is less than or equal to a first time threshold;
accessing a channel using Type 1 listen before talk LBT with the highest channel access priority class or Type 2A LBT, and performing physical sidelink feedback channel PSFCH transmission; and
determining a channel occupancy time COT initiated by a second terminal, and performing the sidelink transmission by sharing the COT initiated by the second terminal; where
the sidelink transmission resource includes at least one of the following: a physical sidelink shared channel PSSCH, a PSFCH, a physical sidelink control channel PSCCH, and an automatic gain control AGC symbol.

According to a third aspect, a terminal is provided. The terminal includes a processor and a memory, where the memory stores a program or instruction capable of running on the processor, and when the program or instruction is executed by the processor, the steps of the method according to the first aspect are implemented.

According to a fourth aspect, a terminal is provided, including a processor and a communication interface, where the communication interface is configured to obtain resource information for sidelink transmission on an unlicensed band; and perform the sidelink transmission by using a first mode based on the resource information; where the first mode includes at least one of the following:
performing the sidelink transmission on multiple sidelink transmission resources, where a first signal is filled between two of the multiple sidelink transmission resources, such that a gap between the two sidelink transmission resources is less than or equal to a first time threshold;
accessing a channel using Type 1 listen before talk LBT with the highest channel access priority class or Type 2A LBT, and performing physical sidelink feedback channel PSFCH transmission; and
determining a channel occupancy time COT initiated by a second terminal, and performing the sidelink transmission by sharing the COT initiated by the second terminal; where
the sidelink transmission resource includes at least one of the following: a physical sidelink shared channel PSSCH, a PSFCH, a physical sidelink control channel PSCCH, and an automatic gain control AGC symbol.

According to a fifth aspect, a sidelink transmission system is provided, including a terminal, where the terminal may be configured to perform the steps of the channel transmission method according to the first aspect.

According to a sixth aspect, a readable storage medium is provided. The readable storage medium stores a program or instruction, and when the program or instruction is executed by a processor, the steps of the method according to the first aspect are implemented.

According to a seventh aspect, a chip is provided. The chip includes a processor and a communication interface, where the communication interface is coupled to the processor, and the processor is configured to run a program or instruction to implement the method according to the first aspect.

According to an eighth aspect, a computer program or program product is provided. The computer program or program product is stored in a storage medium, and the computer program or program product is executed by at least one processor to implement the channel transmission method according to the first aspect.

### BRIEF DESCRIPTION OF DRAWINGS

FIG. 1 is a block diagram of a wireless communication system to which embodiments of this application are applicable;

FIG. 2 is a schematic diagram of sidelink transmission;

FIG. 3 is a schematic flowchart of a channel transmission method according to an embodiment of this application;

FIG. 4 to FIG. 12 are schematic diagrams of a channel transmission method in specific examples of this application;

FIG. 13 is a schematic structural diagram of a channel transmission apparatus according to an embodiment of this application;

FIG. 14 is a schematic structural diagram of a communication device according to an embodiment of this application; and

FIG. 15 is a schematic structural diagram of a terminal according to an embodiment of this application.

### DESCRIPTION OF EMBODIMENTS

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application fall within the protection scope of this application.

The terms “first”, “second”, and the like in the specification and claims of this application are used to distinguish between similar objects rather than to describe a specific order or sequence. It should be understood that terms used in this way is interchangeable in appropriate circumstances such that the embodiments of this application can be implemented in other orders than the order illustrated or described herein. In addition, objects distinguished by “first” and “second” are generally of a same type, and the quantities of the objects are not limited, for example, there may be one or more first objects. In addition, in the specification and claims, “and/or” indicates at least one of the connected objects, and the character “/” generally indicates an “or” relationship between the contextually associated objects.

It should be noted that technologies described in the embodiments of this application are not limited to long term evolution (LTE) or LTE-advanced (LTE-A) systems, and may also be applied to other wireless communication systems, for example, code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” in the embodiments of this application are often used interchangeably, and the technology described herein may be used in the above-mentioned systems and radio technologies as well as other systems and radio technologies. In the following descriptions, a new radio (NR) system is described for illustration purposes, and NR terms are used in most of the following descriptions, although these technologies may also be applied to other applications than the NR system application, for example, the 6th generation (6G) communication system.

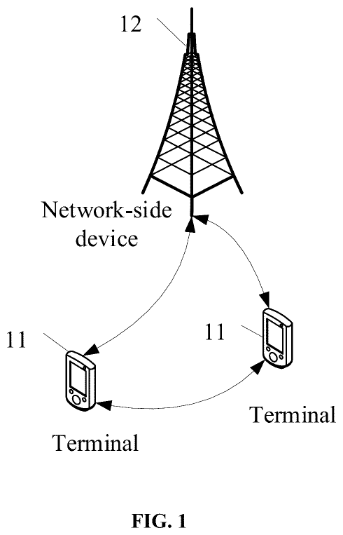

FIG. 1 is a block diagram of a wireless communication system to which the embodiments of this application are applicable. The wireless communication system includes a terminal 11 and a network-side device 12. The terminal 11 may be a terminal-side device, such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart appliance (a home appliance with a wireless communication function, for example, a refrigerator, a television, a washing machine, or furniture), a game console, a personal computer (PC), a teller machine, or a self-service machine. The wearable device includes a smart watch, a smart band, a smart earphone, smart glasses, smart jewelry (a smart bangle, a smart bracelet, a smart ring, a smart necklace, a smart ankle bangle, a smart anklet, or the like), a smart wristband, smart clothing, or the like. It should be noted that the terminal 11 is not limited to any specific type in the embodiments of this application. The network-side device 12 may include an access network device or a core network device. The access network device may also be referred to as a radio access network device, a radio access network (RAN), a radio access network function, or a radio access network unit. The access network device may include a base station, a wireless local area network (WLAN) access point, a wireless fidelity (WiFi) node, or the like. The base station may be referred to as Node B, evolved Node B (eNB), access point, base transceiver station (BTS), radio base station, radio transceiver, basic service set (BSS), extended service set (ESS), home Node B, home evolved Node B, transmitting receiving point (TRP), or other appropriate terms in the field. As long as the same technical effect is achieved, the base station is not limited to any specific technical terminology. It should be noted that in the embodiments of this application, only the base station in the NR system is introduced as an example, and the specific type of the base station is not limited.

Sidelink transmission refers to direct data transmission between terminals (User Equipment, UE) at a physical layer. LTE sidelink implements communication based on broadcasting, and can be used to support basic safety communication of vehicle to everything (V2X). A 5G NR (NR) system supports a more advanced sidelink transmission design, such as unicast, multicast, or groupcast, so as to support more comprehensive service types.

In a future communication system, an unlicensed band can supplement a licensed band to help an operator expand services. To be consistent with NR deployment and maximize NR-based unlicensed access, the unlicensed band can operate on 5 GHz, 37 GHz, and 60 GHz bands. A large bandwidth (80 MHz or 100 MHz) of the unlicensed band can reduce implementation complexity of a base station and UE. Because the unlicensed band is shared by multiple technologies (RATs) such as WiFi, radar, and LTE-license assisted access (LAA), in some countries or regions, the use of the unlicensed band must comply with regulations such as listen before talk (LBT) and maximum channel occupancy time (MCOT), to ensure that all devices can fairly use the resource. When a transmission node needs to transmit information, it first needs to perform LBT and conduct energy detection (ED) on surrounding nodes. When a detected power is lower than a threshold, a channel is considered idle, and the transmission node can transmit the information. Otherwise, the channel is considered busy, and the transmission node cannot transmit the information. The transmission node may be a base station, UE, WiFi access point (AP), or the like. After the transmission node starts the transmission, a channel occupancy time (COT) cannot exceed the MCOT. In addition, according to an occupied channel bandwidth (OCB) regulation, on the unlicensed band, the transmission node needs to occupy at least 70% (60 GHz) or 80% (5 GHz) of the bandwidth of the entire band during each transmission.

The type of LBT commonly used in NR in unlicensed spectrum (NRU) may include Type 1, Type 2A, Type 2B, and Type 2C. Type 1 LBT is a back-off based channel listening mechanism. When the transmission node detects that the channel is busy, it backs off and continues listening until it detects that the channel is idle. Type 2C means that the transmission node does not perform LBT, namely no LBT or immediate transmission. Type 2A and Type 2B LBT are one-shot LBT, that is, the node performs LBT once before transmission. If the channel is idle, the node transmits; and if the channel is busy, the node does not transmit. The difference is that Type 2A performs LBT within 25 us and is applicable in a case that a gap between two transmissions within a shared COT is greater than or equal to 25 us. Type 2B performs LBT within 16 us and is applicable in a case that a gap between two transmissions within a shared COT is equal to 16 us. In addition, there is Type 2 LBT applicable to LAA/enhanced LAA (eLAA)/further enhanced LAA (FeLAA). In a case that a gap between two transmissions within a shared COT is greater than or equal to 25 us, eNB and UE can use Type 2 LBT. In addition, in frequency range 2-2, the type of LBT includes Type 1, Type 2, and Type 3. Type 1 is a back-off based channel listening mechanism, Type 2 is one-shot LBT and performs 5 us of LBT within 8 us, and Type 3 does not perform LBT.

A downlink (DL)/uplink (UL) transmission burst is a set of transmissions sent by a base station or UE, with gaps being not greater than 16 us. For transmissions in a DL/UL transmission burst, the base station or UE can transmit directly without performing LBT after the gap. In a case that gaps between transmissions are greater than 16 us, they can be considered as a separate DL/UL transmission burst.

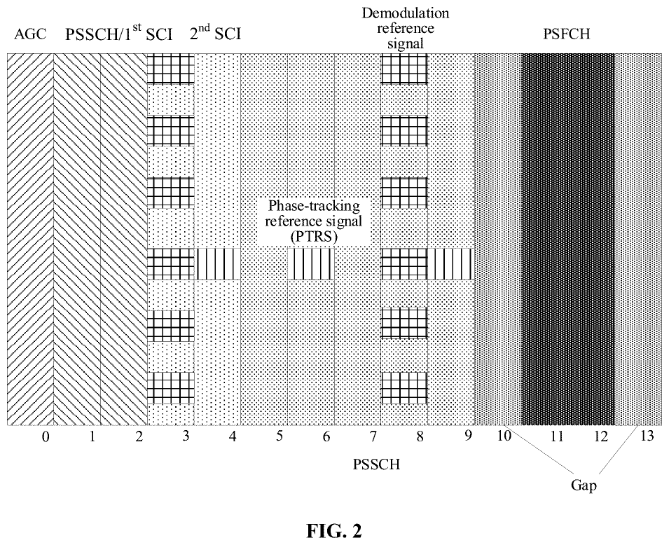

As shown in FIG. 2, an automatic gain control (AGC) symbol is needed before each sidelink (SL) transmission, and a gap symbol is needed after each transmission. The AGC symbol is typically a repeated transmission of the next symbol, such as a physical sidelink control channel (PSCCH), a physical sidelink shared channel (PSSCH), or a physical sidelink feedback channel (PSFCH). In the figure, for the PSFCH consisting of two symbols, the first symbol is used for AGC. The time required for the UE to perform AGC is related to a subcarrier spacing (SCS). For a 15 KHz SCS, the AGC time is less than or equal to 35 us. For a 30 KHz SCS, the AGC time is less than or equal to 18 us. For a 60 KHz SCS, the AGC time is less than or equal to 9 us.

The following describes in detail the channel transmission method provided in the embodiments of this application through some embodiments and application scenarios thereof with reference to the accompanying drawings.

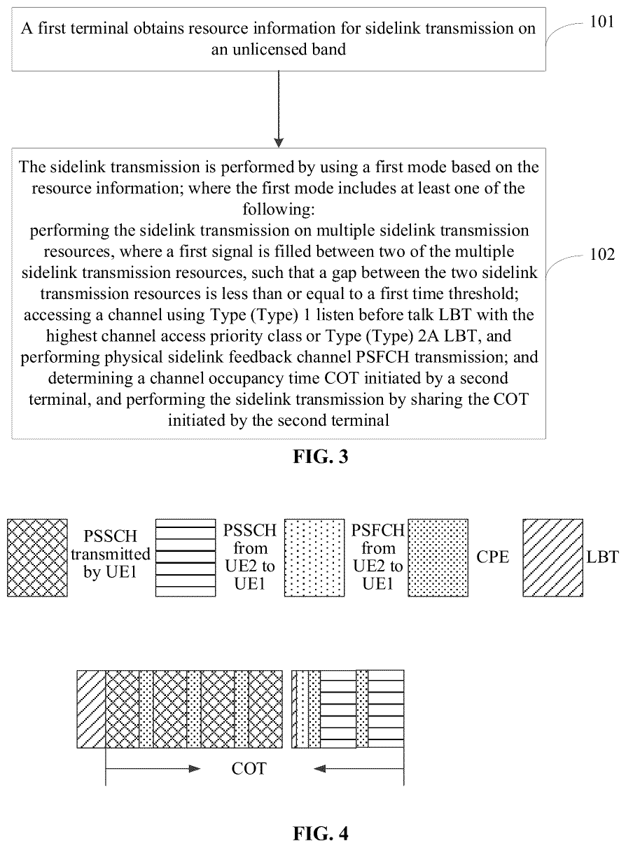

An embodiment of this application provides a channel transmission method. As shown in FIG. 3, the method includes the following steps.

Step 101. A first terminal obtains resource information for sidelink transmission on an unlicensed band.

Step 102. The sidelink transmission is performed by using a first mode based on the resource information; where the first mode includes at least one of the following:
performing the sidelink transmission on multiple sidelink transmission resources, where a first signal is filled between two of the multiple sidelink transmission resources, such that a gap between the two sidelink transmission resources is less than or equal to a first time threshold;
accessing a channel using Type 1 listen before talk LBT with the highest channel access priority class or Type 2A LBT, and performing physical sidelink feedback channel PSFCH transmission; and
determining a channel occupancy time COT initiated by a second terminal, and performing the sidelink transmission by sharing the COT initiated by the second terminal; where
the sidelink transmission resource includes at least one of the following: a physical sidelink shared channel PSSCH, a PSFCH, a physical sidelink control channel PSCCH, and an automatic gain control AGC symbol.

The first time threshold needs to ensure that the sidelink transmission is a transmission burst, which can reduce the number of times and/or the time for channel listening by the first terminal. The first time threshold may be an absolute duration or the number of slots, minislots, or symbols. Specifically, the first time threshold needs to be less than or equal to 16 us.

In this embodiment, the first terminal accesses the channel, including accessing the channel using Type 1 LBT, or accessing the channel within a shared COT using Type 2A, Type 2B, or Type 2C.

In a case that the channel is accessed using the highest channel access priority class of Type 1 LBT for the PSFCH transmission, the time for channel listening by the first terminal can be reduced, and the obtained COT can be shared with other terminals, which can reduce the number of times and/or the time for channel listening by the other terminals, thereby improving transmission efficiency.

In a case that the channel is accessed using Type 2A listen before talk LBT for the PSFCH transmission, the time for channel listening by the first terminal can be reduced, thereby improving the transmission efficiency.

After the COT initiated by the second terminal is determined, transmission information of the COT of the second terminal can be shared, which can reduce the number of times and/or the time for channel listening by the first terminal, thereby improving the transmission efficiency.

The time for channel listening by the first terminal can be reduced, and the obtained COT can be shared with other terminals.

In some embodiments, in a case that two sidelink transmission resources are adjacent, the two sidelink transmission resources include a first transmission resource and a second PSSCH or first PSFCH before the first transmission resource, and the method further includes:
transmitting the first signal before a start time of the first transmission resource; and/or
transmitting the first signal after an end time of the second PSSCH or first PSFCH; where
the first transmission resource includes at least one of a first PSSCH, a first PSCCH, and the automatic gain control AGC symbol.

For example, for a first PSSCH (for example, slot n) transmitted by the first terminal, if there is a second PSSCH (or first PSFCH) transmitted by the UE before the first PSSCH (for example, slot n−1), the first signal is transmitted before a start time of the first PSSCH and/or after an end time of the second PSSCH (or first PSFCH).

In some embodiments, the first terminal accesses a sidelink channel with a first priority class, a channel access priority class of data transmitted by the first terminal within a COT is higher than or equal to the first priority class, and the COT includes a COT initiated by the first terminal and the shared COT initiated by the second terminal.

In some embodiments, the first PSSCH is located within a COT in which the second PSSCH or the first PSFCH is located, and the COT includes a COT initiated by the first terminal and the shared COT initiated by the second terminal.

In some embodiments, a time gap between the start time of the first PSSCH and the end time of the second PSSCH or first PSFCH is D, and a length of the first signal is greater than or equal to D−Y, where Y is the first time threshold, such as 16 us, and Y may be agreed by a protocol, configured by a network-side device, or preconfigured.

In some embodiments, in a case that the first signal is transmitted before the start time of the first transmission resource, the first signal includes at least one of the following:
a cyclic prefix (CP) extension for the first PSSCH;
a CP extension for an automatic gain control AGC symbol of the first PSSCH;
at least part of a specific symbol of the first PSSCH; and
a specific pilot signal.

In some embodiments, in a case that the first signal is transmitted after the end time of the second PSSCH or first PSFCH, the first signal includes at least one of the following:
an AGC symbol of the second PSSCH;
at least part of a specific symbol of the second PSSCH; and
a specific pilot signal.

On the unlicensed band, to improve the transmission efficiency, after the UE accesses the channel, that is, it is detected that the channel is idle, the UE performs continuous transmission as much as possible within the COT to avoid additional LBT. To ensure the continuity of transmission, gaps between multiple SL transmissions by the UE must be less than or equal to 16 us. As shown in FIG. 2, the gap between the PSSCH and the PSFCH is one symbol. Even with a 60 KHz SCS, the gap is still greater than 16 us. Therefore, after acquiring the channel, the UE fills all the gaps between the SL transmissions that need to be sent, that is, transmitting the first signal in the gap to make it less than or equal to 16 us, thereby avoiding channel listening. In a specific example, the gap can be filled with an enhanced cyclic prefix CPE, that is, transmitting the CPE in all the gaps between the SL transmissions that need to be sent.

In this embodiment, the SL transmission includes at least one of the following: PSCCH, PSSCH, and PSFCH. The SL transmission may further include an AGC symbol.

Type 1 LBT has four channel access priority classes (CAPC), and each CAPC corresponds to a maximum channel occupancy time MCOT. p=1 is the highest priority class, and p=4 is the lowest priority class. A priority class of information transmitted within a COT cannot be lower than a priority class of the COT, that is, a CAPC value of the transmitted information is less than or equal to a CAPC value used to obtain the COT. A channel access priority class of SL transmission from the UE within a COT must be higher than or equal to a channel access priority class corresponding to the SL transmission used to obtain the COT, that is, a channel access priority class value of the SL transmission by the UE within the COT must be lower than or equal to a channel access priority class value corresponding to the SL transmission used to obtain the COT.

As shown in FIG. 4, after UE1 accesses the channel using LBT and obtains the COT, the UE1 fills all the gaps between the PSSCHs (that is, transmitting the first signal in the gap) when transmitting the PSSCH, making the SL transmission continuous. After receiving the information transmitted by the UE1 (PSCCH and/or PSSCH), UE2 transmits the PSFCH and/or the PSSCH to the UE1. The UE2 can share the COT of the UE1 and access the channel using Type 2A LBT. In this case, the gap between the PSSCH and the PSFCH does not need to be filled (that is, the first signal is not transmitted in the gap). If the UE2 needs to access the channel using Type 2B or Type 2C, the gap between the PSSCH and the PSFCH needs to be filled with the CPE (that is, the CPE is transmitted in the gap) to 16 us or less than 16 us. After accessing the channel, the UE2 fills the gaps between the PSFCH and the multiple PSSCH transmissions (that is, transmitting the first signal in the gap) to implement continuous transmission.

Because the information carried on the PSFCH channel is important and the transmission time is very short, Type 2A LBT or the highest priority class of Type 1 LBT can be used as the channel access type for the PSFCH.

In some embodiments, in a case that the first terminal accesses the channel using Type 2A LBT and a subcarrier spacing is 60 KHz, the method further includes:
performing, by the first terminal, a puncturing operation in the first A microseconds of the first PSFCH symbol following a gap symbol, and transmitting the last B microseconds of the first PSFCH symbol, where a length of the first PSFCH symbol is A+B microseconds, and A and B are positive integers; and
performing, by the first terminal, channel listening in the gap symbol before the first PSFCH symbol and the first A microseconds of the first PSFCH symbol.

In a case that the first terminal accesses the channel using Type 2A LBT, for 15 KHz and 30 KHz SCSs, the UE performs 25 us LBT immediately before the PSFCH in the gap symbol before the PSFCH. For a 60 KHz SCS, because the size of the gap symbol is less than 25 us, there is not enough time to perform LBT. To ensure sufficient time for channel listening, the UE transmits only the last B microseconds of the first PSFCH symbol, such as the last 9 us, and performs Type 2A LBT in the first A microseconds of the first PSFCH symbol and the gap symbol, as shown in FIG. 5. In this embodiment, the COT obtained using Type 2A LBT can only be used for the PSFCH transmission and cannot be shared with other UEs.

In some embodiments, the number of gap symbols is configured by a network-side device, preconfigured, or agreed by a protocol, and the number may be a number other than 1 symbol, such as 1 symbol, 2 symbols, 3 symbols, or 0.5 symbols.

In some embodiments, the number of gap symbols is related to the SCS.

In some embodiments, in a case that the first terminal accesses the channel using the highest channel access priority class of Type 1 LBT for the PSFCH transmission, the method further includes:
sharing a COT of the first terminal with a third terminal, such that the third terminal transmits at least one of the following within the COT of the first terminal: the PSCCH, the PSSCH, the PSFCH, and the AGC symbol, where a channel access priority class of the PSSCH is the highest priority class.

The channel access type for the third terminal may be Type 2A. The related information of the COT may be agreed by a protocol or obtained from the first terminal.

In a case that the UE accesses the channel using the highest priority class (p=1) of Type 1 LBT for the PSFCH transmission, a transmit terminal (Transmit UE, Tx UE) of the PSFCH can share the COT with a receive terminal (Receive UE, Rx UE) of the PSFCH. In this case, the Rx UE of the PSFCH can transmit the PSCCH, the PSSCH, and/or the PSFCH to the Tx UE of the PSFCH. The channel access priority class of the PSSCH must also be p=1; otherwise, the Rx UE of the PSFCH cannot share the channel to transmit the PSSCH. When sharing the channel, the Rx UE of the PSFCH can access the channel using Type 2A, Type 2B, or Type 2C LBT. When accessing the channel using Type 2B or Type 2C LBT, the Rx UE of the PSFCH needs to fill the gap between the SL transmissions (that is, transmitting the first signal in the gap) to meet the gap requirements of Type 2B or Type 2C, that is, less than or equal to 16 us.

In this embodiment, the terminal can perform the SL transmission through the shared COT. In a case that the SL transmission is performed through the shared COT, the time and the number of times for channel listening can be reduced, thereby improving the transmission efficiency. In a case that the SL transmission is performed through the shared COT, the method further includes:
obtaining information of the shared COT initiated by the second terminal, where a start time and end time of the shared COT are determined by a PSFCH period and/or a channel access priority class indicated in sidelink control information SCI.

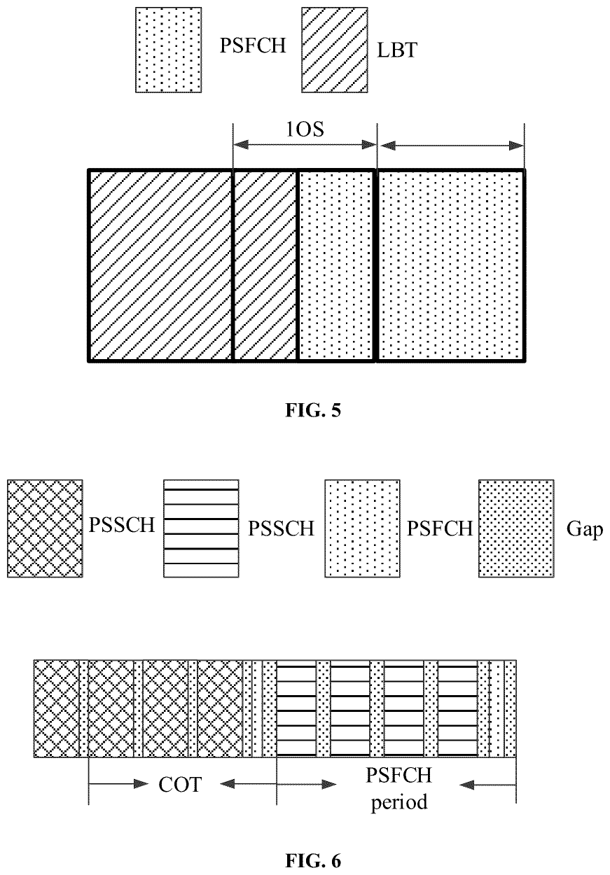

In a specific embodiment, within a PSFCH period, if the Rx UE receives the information transmitted by the Tx UE, it can share the COT of the Tx UE for the PSCCH/PSSCH transmission before the PSFCH. A (virtual) end position of the COT of the Tx UE can be determined by the PSFCH position and/or period and the priority indicated in the sidelink control information (SCI). The priority indicated in the 1st stage SCI has a mapping relationship with the channel access priority class, and the Rx UE can implicitly obtain the length of the COT through the priority. As shown in FIG. 6, in a case that the Rx UE receives the PSSCH in the second slot of the first PSFCH period, the Rx UE assumes this slot as a start position of the COT. Based on the start position and the length of the COT, if the end position of the COT is inferred to be before the PSFCH, the end position of the COT is determined according to the length of the COT. If the end position of the COT is inferred to be after the PSFCH, the end position of the COT is the PSFCH.

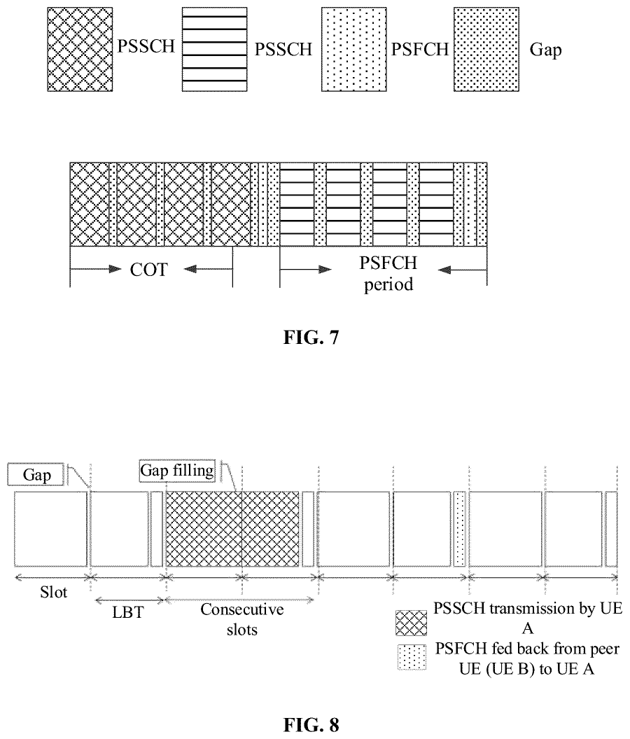

In another implementation, the virtual start position of the COT is inferred based on the PSFCH period, and the end position of the COT is determined based on the length of the COT implicitly obtained through the priority in the SCI. As shown in FIG. 7, in a case that the Rx UE detects the information transmitted by the Tx UE in any slot of the PSFCH period, the UE assumes that the start position of the COT of the Tx UE is a start position of the PSFCH period. In a case that the length of the COT corresponding to the priority is less than or equal to the PSFCH period, the end position of the COT is obtained based on the start position of the PSFCH period and the length of the COT; and in a case that the length of the COT corresponding to the priority is greater than the PSFCH period, the end position of the COT is an end position of the PSFCH period.

In another specific embodiment, the method further includes:
obtaining, by the first terminal, a shared COT duration of the COT initiated by the second terminal, where the duration of the shared COT is indicated by a specific sequence or signal transmitted by the second terminal in the gap of a symbol.

After the Tx UE accesses the channel, the Tx UE performs continuous transmission as much as possible to avoid additional LBT, thereby improving the transmission efficiency. Therefore, the Rx UE can determine the information of the COT by detecting the gap symbol. The Tx UE (that is, the second terminal) can transmit a specific sequence or signal in the gap symbol. Different sequences or signals can represent different COT durations, and correspondences between the different sequences or signals and the COT durations may be configured by a network-side device, preconfigured, or agreed by a protocol. After detecting the specific sequence or signal, the Rx UE (that is, the first terminal) can obtain the corresponding COT duration, and thus determines whether the COT of the Tx UE can be shared.

In another specific embodiment, a duration shared by the first terminal of the COT of the second terminal is determined by a value of a COT duration field in first SCI received by the first terminal from a second terminal side. In a case that the first terminal shares the COT initiated by the second terminal, a value of a COT duration field in second SCI transmitted by the first terminal is 0 or an invalid value.

The Tx UE (that is, the second terminal) can indicate the COT duration in the SCI, and all Rx UEs (that is, the first terminal) that receive the SCI can share the COT of the Tx UE. The recipient of the PSCCH, PSSCH, and/or PSFCH transmitted by the Rx UE includes at least the Tx UE. The COT duration indicated in the SCI transmitted by the Rx UE is zero or an invalid value. In this way, the UE that receives the SCI transmitted by the Rx UE does not assume that the Rx UE has initiated the COT and does not further share the COT.

In a case that a shared COT and a non-shared COT are simultaneously indicated to the first terminal, the first terminal preferentially uses the shared COT to transmit data. In other words, in a case that COT sharing and non-COT sharing are simultaneously indicated to the UE, the UE preferentially uses the COT sharing for information transmission based on the information of the COT, which can reduce the number of times and the time for channel listening, thereby improving the transmission efficiency. Information that cannot be transmitted within the COT can be transmitted using the non-COT sharing, meaning that the UE performs channel access and transmission according to the indicated Type 1 LBT.

In another specific embodiment, resources of the COT initiated by the second terminal shared by the first terminal may be indicated by a resource selection window location field in SCI 2-C;
or
the resources of the shared COT are jointly indicated by a resource combinations field, a first resource location field, a reference slot location field, and a number of subchannels field in the SCI 2-C. In a case that the UE receives the SCI 2-C, it defaults to assuming that the indicated resources are all resources within the shareable COT, and accesses the channel using Type 2A for transmission on the indicated resources. In a case that the UE receives an indication from SCI 2-A or SCI 2-B, it defaults to assuming that there is no COT to share, and all the SL transmissions use Type 1 LBT to access the channel.

In a specific embodiment, the UE selects consecutive slots in absolute time for the PSSCH transmission. If the UE can ensure uninterrupted transmission (that is, the gap between the signals transmitted by the UE is less than or equal to 16 us), after successfully performing LBT, the UE can transmit the signals in the consecutive slots to improve LBT efficiency. The first mode further includes:
transmitting, by the first terminal, the first signal in a PSFCH symbol, where the first signal includes a virtual PSFCH.

The form of the consecutive slots selected by the UE may have multiple cases.

First case: There is no PSFCH occasion between the consecutive slots. As shown in FIG. 8, the terminal only needs to fill the gap symbol between the PSSCH and the PSSCH, that is, only transmitting the first signal in the gap symbol between the PSSCH and the PSSCH.

Second case: There is a PSFCH occasion between the consecutive slots. In this case, the UE needs to handle the PSFCH symbol and the gaps before and after the PSFCH to avoid negatively impacting other UEs in the system performing CCA while transmitting the PSFCH, or to avoid the UE being unable to receive the required PSFCH.

In a scenario, the UE cannot fill the PSFCH symbol and/or the gaps before and after the PSFCH, that is, not transmitting the first signal in the PSFCH symbol and/or the gaps before and after the PSFCH, as shown in FIG. 9. Alternatively, as prescribed by a protocol, when the UE actively selects consecutive slots (using N consecutive slots as candidate resources for resource selection), the consecutive slots cannot include a PSFCH occasion (for example, except for the last slot, other slots cannot include the PSFCH occasion).

In another scenario, the UE can conditionally fill the PSFCH symbol and/or the gaps before and after the PSFCH, that is, conditionally transmitting the first signal in the PSFCH symbol and/or the gaps before and after the PSFCH.

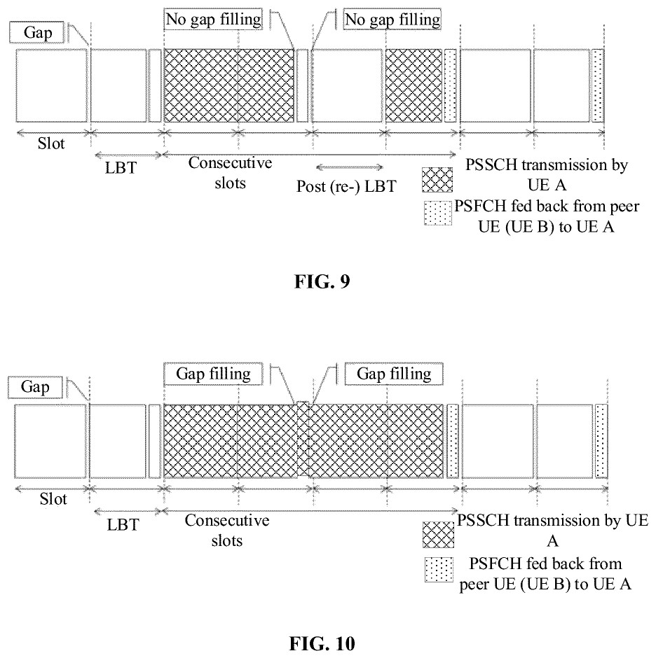

If the same UE performs the PSFCH transmission and the PSSCH transmission, as shown in FIG. 10, it fills the gaps between the PSSCH and the PSFCH as well as between the PSFCH and the PSSCH.

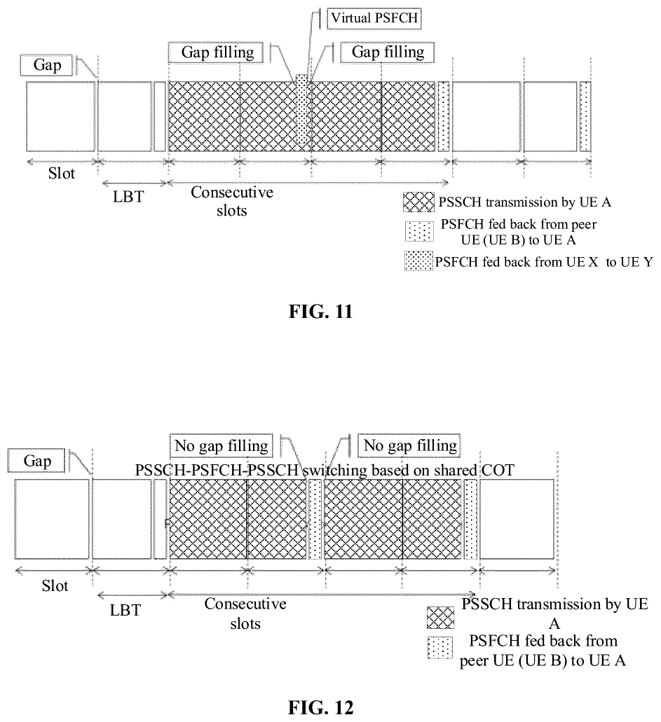

If different UEs perform the PSFCH transmission and the PSSCH transmission and the UE performing the PSSCH transmission does not need to receive the PSFCH, as shown in FIG. 11, the UE fills the PSFCH symbol and the gaps before and after the PSFCH. The UE can transmit a virtual PSFCH to fill the PSFCH, that is, transmitting the virtual PSFCH on the PSFCH.

If different UEs perform the PSFCH transmission and the PSSCH transmission and the UE performing the PSSCH transmission needs to receive the PSFCH, the UE follows at least one of the following rules.

First rule: The UE does not fill the PSFCH symbol and the gaps before and after the PSFCH to ensure the reception of the PSFCH.

Second rule: The UE can fill the PSFCH symbol and the gaps before and after the PSFCH to ensure continuous transmission of the PSSCH.

The behavior of the first rule or the second rule may be configured by a network side and/or agreed by a protocol; or the use of the first rule or the second rule is determined based on the priority of the PSFCH and PSSCH transmissions, to ensure the reception of high-priority information.

If different UEs perform the PSFCH transmission and the PSSCH transmission, the UE performing the PSSCH transmission needs to receive the PSFCH, and the PSFCH is transmitted by peer UE of the PSSCH transmission (for example, the PSFCH is used for PSSCH feedback), the UE follows at least one of the following rules.

Third rule: The UE does not fill the PSFCH symbol and the gaps before and after the PSFCH to ensure the reception of the PSFCH.

Fourth rule: The UE can fill the PSFCH symbol and the gaps before and after the PSFCH to ensure continuous transmission of the PSSCH.

Fifth rule: As shown in FIG. 12, the UE does not fill the PSFCH symbol and the gaps before and after the PSFCH to ensure the reception of the PSFCH. After the PSFCH, the UE can still transmit the PSSCH in the next PSSCH slot (assuming that the UE performing the PSSCH transmission shares the COT with the transmit end UE of the PSFCH, and then reuses the COT to transmit the PSSCH).

The channel transmission method provided in the embodiments of this application can be performed by a channel transmission apparatus. In the embodiments of this application, the channel transmission method being performed by the channel transmission apparatus is used as an example to describe the channel transmission apparatus provided in the embodiments of this application.

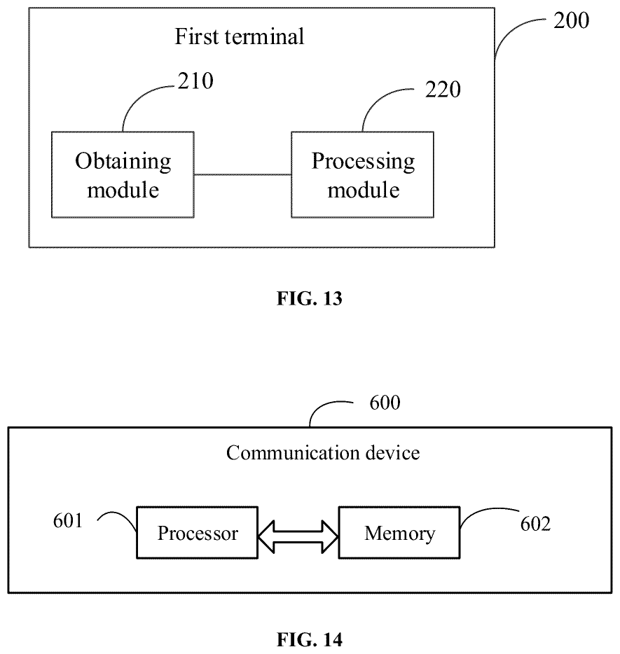

An embodiment of this application provides a channel transmission apparatus. As shown in FIG. 13, the channel transmission apparatus is applied to a first terminal 200 and includes:
an obtaining module 210 configured to obtain resource information for sidelink transmission on an unlicensed band; and
a processing module 220 configured to perform the sidelink transmission by using a first mode based on the resource information; where the first mode includes at least one of the following:
performing the sidelink transmission on multiple sidelink transmission resources, where a first signal is filled between two of the multiple sidelink transmission resources, such that a gap between the two sidelink transmission resources is less than or equal to a first time threshold;
accessing a channel using Type 1 listen before talk LBT with the highest channel access priority class or Type 2A LBT, and performing physical sidelink feedback channel PSFCH transmission; and
determining a channel occupancy time COT initiated by a second terminal, and performing the sidelink transmission by sharing the COT initiated by the second terminal; where
the sidelink transmission resource includes at least one of the following: a physical sidelink shared channel PSSCH, a PSFCH, a physical sidelink control channel PSCCH, and an automatic gain control AGC symbol.

The first time threshold needs to ensure that the sidelink transmission is a transmission burst, which can reduce the number of times and/or the time for channel listening by the first terminal. The first time threshold may be an absolute duration or the number of slots, minislots, or symbols. Specifically, the first time threshold needs to be less than or equal to 16 us.

In this embodiment, the first terminal accesses the channel, including accessing the channel using Type 1 LBT, or accessing the channel within a shared COT using Type 2A, Type 2B, or Type 2C.

In a case that the channel is accessed using the highest channel access priority class of Type 1 LBT for the PSFCH transmission, the time for channel listening by the first terminal can be reduced, and the obtained COT can be shared with other terminals, which can reduce the number of times and/or the time for channel listening by the other terminals, thereby improving transmission efficiency.

In a case that the channel is accessed using Type 2A listen before talk LBT for the PSFCH transmission, the time for channel listening by the first terminal can be reduced, thereby improving the transmission efficiency.

After the COT initiated by the second terminal is determined, transmission information of the COT of the second terminal can be shared, which can reduce the number of times and/or the time for channel listening by the first terminal, thereby improving the transmission efficiency.

In some embodiments, in a case that two sidelink transmission resources are adjacent, the two sidelink transmission resources include a first transmission resource and a second PSSCH or first PSFCH before the first transmission resource.

The processing module 220 is specifically configured to transmit the first signal before a start time of the first transmission resource; and/or
transmit the first signal after an end time of the second PSSCH or first PSFCH; where the first transmission resource includes at least one of a first PSSCH, a first PSCCH, and the automatic gain control AGC symbol.

In some embodiments, the first terminal accesses a sidelink channel with a first priority class, a channel access priority class of data transmitted by the first terminal within a COT is higher than or equal to the first priority class, and the COT includes a COT initiated by the first terminal and the shared COT initiated by the second terminal.

In some embodiments, the first PSSCH is located within a COT in which the second PSSCH or the first PSFCH is located, and the COT includes a COT initiated by the first terminal and the shared COT initiated by the second terminal.

In some embodiments, a time gap between the start time of the first PSSCH and the end time of the second PSSCH or first PSFCH is D, and a length of the first signal is greater than or equal to D−Y, where Y is the first time threshold.

In some embodiments, in a case that the first signal is transmitted before the start time of the first transmission resource, the first signal includes at least one of the following:
a cyclic prefix CP extension for the first PSSCH;
a CP extension for an automatic gain control AGC symbol of the first PSSCH;
at least part of a specific symbol of the first PSSCH; and
a specific pilot signal.

In some embodiments, in a case that the first signal is transmitted after the end time of the second PSSCH or first PSFCH, the first signal includes at least one of the following:
an AGC symbol of the second PSSCH;
at least part of a specific symbol of the second PSSCH; and
a specific pilot signal.

In some embodiments, in a case that the first terminal accesses the channel using Type 2A LBT and a subcarrier spacing is 60 KHz, the processing module 220 is configured to perform a puncturing operation in the first A microseconds of the first PSFCH symbol following a gap symbol, and transmit the last B microseconds of the first PSFCH symbol, where a length of the first PSFCH symbol is A+B microseconds, and A and B are positive integers.

In some embodiments, the processing module 220 is configured to perform channel listening in the gap symbol before the first PSFCH symbol and the first A microseconds of the first PSFCH symbol.

In some embodiments, the number of gap symbols is configured by a network-side device, preconfigured, or agreed by a protocol.

In some embodiments, the number of gap symbols is related to the SCS.

In some embodiments, in a case that the first terminal accesses the channel using the highest channel access priority class of Type 1 LBT for the PSFCH transmission, the processing module 220 is configured to share a COT of the first terminal with a third terminal, such that the third terminal transmits at least one of the following within the COT of the first terminal: the PSCCH, the PSSCH, the PSFCH, and the AGC symbol, where a channel access priority class of the PSSCH is the highest priority class.

In some embodiments, the third terminal transmits at least one of the following within the shared COT of the first terminal: the PSCCH, the PSSCH, the PSFCH, and the AGC symbol, where a channel access priority class of the PSSCH is the highest priority class.

In some embodiments, the processing module 220 is further configured to obtain shared COT information of the COT initiated by the second terminal, where a start time and end time of the shared COT are determined by a PSFCH period and/or a channel access priority class indicated in sidelink control information SCI.

In some embodiments, the processing module 220 is further configured to obtain a shared COT duration of the COT initiated by the second terminal, where the duration of the shared COT is indicated by a specific sequence or signal transmitted by the second terminal in the gap of a symbol.

In some embodiments, a duration shared by the first terminal of the COT of the second terminal is determined by a value of a COT duration field in first SCI received by the first terminal from a second terminal side.

In some embodiments, in a case that the first terminal shares the COT initiated by the second terminal, a value of a COT duration field in second SCI transmitted by the first terminal is 0 or an invalid value.

In some embodiments, resources of the COT initiated by the second terminal shared by the first terminal are indicated by a resource selection window location Resource selection window location field in SCI 2-C;
or
the resources of the COT initiated by the second terminal shared by the first terminal are jointly indicated by a resource combinations Resource combinations field, a first resource location First resource location field, a reference slot location Reference slot location field, and a number of subchannels Number of subchannels field in the SCI 2-C.

In some embodiments, in a case that a PSFCH occasion is present between consecutive slots consecutive slots in absolute time, the processing module 220 transmits the first signal in a PSFCH symbol, where the first signal includes a virtual PSFCH.

The channel transmission apparatus in the embodiments of this application may be an electronic device, for example, an electronic device with an operating system, or may be a component in an electronic device, for example, an integrated circuit or a chip. The electronic device may be a terminal or other devices than terminals. For example, the terminal may include but is not limited to the types of the terminal 11 listed above, and the other devices may be servers, network attached storage (NAS), or the like, which are not specifically limited in the embodiments of this application.

The channel transmission apparatus provided in this embodiment of this application can implement the processes implemented in the method embodiments in FIG. 3 to FIG. 12, with the same technical effects achieved. To avoid repetition, details are not described herein again.

Optionally, as shown in FIG. 14, an embodiment of this application further provides a communication device 600 including a processor 601 and a memory 602. The memory 602 stores a program or instruction capable of running on the processor 601. For example, in a case that the communication device 600 is a terminal, when the program or instruction is executed by the processor 601, the steps of the foregoing channel transmission method embodiments are implemented, with the same technical effects achieved. To avoid repetition, details are not described herein again.

An embodiment of this application further provides a terminal. The terminal includes a processor and a memory, where the memory stores a program or instruction capable of running on the processor, and when the program or instruction is executed by the processor, the steps of the channel transmission method are implemented.

An embodiment of this application further provides a terminal including a processor and a communication interface, where the communication interface is configured to obtain resource information for sidelink transmission on an unlicensed band; and perform the sidelink transmission by using a first mode based on the resource information; where the first mode includes at least one of the following:
performing the sidelink transmission on multiple sidelink transmission resources, where a first signal is filled between two of the multiple sidelink transmission resources, such that a gap between the two sidelink transmission resources is less than or equal to a first time threshold;
accessing a channel using Type 1 listen before talk LBT with the highest channel access priority class or Type 2A LBT, and performing physical sidelink feedback channel PSFCH transmission; and
determining a channel occupancy time COT initiated by a second terminal, and performing the sidelink transmission by sharing the COT initiated by the second terminal; where
the sidelink transmission resource includes at least one of the following: a physical sidelink shared channel PSSCH, a PSFCH, a physical sidelink control channel PSCCH, and an automatic gain control AGC symbol.

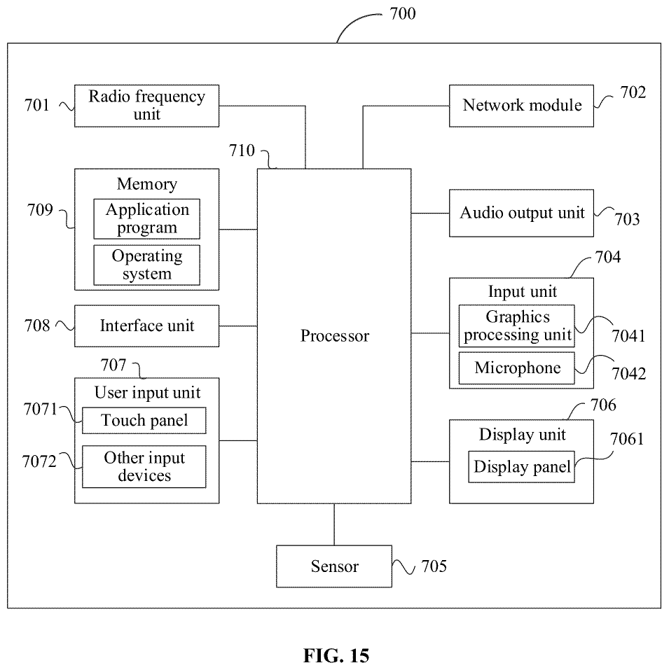

An embodiment of this application further provides a terminal including a processor and a communication interface. This terminal embodiment corresponds to the foregoing method embodiment on the terminal side. All processes and implementations in the foregoing method embodiment are applicable to this terminal embodiment, with the same technical effects achieved. Specifically, FIG. 15 is a schematic diagram of a hardware structure of a terminal implementing the embodiments of this application.

The terminal 700 includes but is not limited to at least some of these components: a radio frequency unit 701, a network module 702, an audio output unit 703, an input unit 704, a sensor 705, a display unit 706, a user input unit 707, an interface unit 708, a memory 709, and a processor 710.

Persons skilled in the art can understand that the terminal 700 may further include a power supply (for example, a battery) for supplying power to the components. The power supply may be logically connected to the processor 710 via a power management system, so that functions such as charge management, discharge management, and power consumption management are implemented via the power management system. The terminal structure shown in FIG. 15 does not constitute any limitation on the terminal. The terminal may include more or fewer components than shown in the figure, or combine some of the components, or arrange the components differently. Details are not described herein.

It should be understood that in the embodiments of this application, the input unit 704 may include a graphics processing unit (GPU) 7041 and a microphone 7042. The graphics processing unit 7041 processes image data of a static picture or a video that is obtained by an image capture apparatus (for example, a camera) in an image capture mode or a video capture mode. The display unit 706 may include a display panel 7061. The display panel 7061 may be configured in a form of a liquid crystal display, an organic light-emitting diode display, or the like. The user input unit 707 includes at least one of a touch panel 7071 and other input devices 7072. The touch panel 7071 is also referred to as a touchscreen. The touch panel 7071 may include two parts: a touch detection apparatus and a touch controller. The other input devices 7072 may include but are not limited to a physical keyboard, a function button (for example, a volume control button or an on/off button), a trackball, a mouse, and a joystick. Details are not described herein.

In an embodiment of this application, the radio frequency unit 701 receives downlink data from a network-side device and sends the data to the processor 710 for processing; and the radio frequency unit 701 can additionally send uplink data to the network-side device. Generally, the radio frequency unit 701 includes but is not limited to an antenna, an amplifier, a transceiver, a coupler, a low noise amplifier, and a duplexer.

The memory 709 may be configured to store a software program or instruction and various data. The memory 709 may mainly include a first storage area for storing programs or instructions and a second storage area for storing data. The first storage area may store an operating system, an application program or instruction required by at least one function (for example, a sound play function or an image play function), and the like. Additionally, the memory 709 may be a volatile memory or a non-volatile memory, or the memory 709 may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), and a direct rambus random access memory (Direct Rambus RAM, DRRAM). The memory 709 in the embodiments of this application includes but is not limited to these and any other applicable types of memories.

The processor 710 may include one or more processing units. Optionally, the processor 710 integrates an application processor and a modem processor. The application processor primarily processes operations involving an operating system, user interface, application program, and the like. The modem processor primarily processes radio communication signals, for example, being a baseband processor. It can be understood that the modem processor may alternatively be not integrated into the processor 710.

In some embodiments, the processor 710 is configured to obtain resource information for sidelink transmission on an unlicensed band; and perform the sidelink transmission by using a first mode based on the resource information; where the first mode includes at least one of the following:
performing the sidelink transmission on multiple sidelink transmission resources, where a first signal is filled between two of the multiple sidelink transmission resources, such that a gap between the two sidelink transmission resources is less than or equal to a first time threshold;
accessing a channel using Type 1 listen before talk LBT with the highest channel access priority class or Type 2A LBT, and performing physical sidelink feedback channel PSFCH transmission; and
determining a channel occupancy time COT initiated by a second terminal, and performing the sidelink transmission by sharing the COT initiated by the second terminal; where
the sidelink transmission resource includes at least one of the following: a physical sidelink shared channel PSSCH, a PSFCH, a physical sidelink control channel PSCCH, and an automatic gain control AGC symbol.

The first time threshold needs to ensure that the sidelink transmission is a transmission burst, which can reduce the number of times and/or the time for channel listening by the first terminal. The first time threshold may be an absolute duration or the number of slots, minislots, or symbols. Specifically, the first time threshold needs to be less than or equal to 16 us.

In this embodiment, the first terminal accesses the channel, including accessing the channel using Type 1 LBT, or accessing the channel within a shared COT using Type 2A, Type 2B, or Type 2C.

In a case that the channel is accessed using the highest channel access priority class of Type 1 LBT for the PSFCH transmission, the time for channel listening by the first terminal can be reduced, and the obtained COT can be shared with other terminals, which can reduce the number of times and/or the time for channel listening by the other terminals, thereby improving transmission efficiency.

In a case that the channel is accessed using Type 2A listen before talk LBT for the PSFCH transmission, the time for channel listening by the first terminal can be reduced, thereby improving the transmission efficiency.

After the COT initiated by the second terminal is determined, transmission information of the COT of the second terminal can be shared, which can reduce the number of times and/or the time for channel listening by the first terminal, thereby improving the transmission efficiency.

In some embodiments, in a case that two sidelink transmission resources are adjacent, the two sidelink transmission resources include a first transmission resource and a second PSSCH or first PSFCH before the first transmission resource.

The processor 710 is specifically configured to transmit the first signal before a start time of the first transmission resource; and/or
transmit the first signal after an end time of the second PSSCH or first PSFCH; where
the first transmission resource includes at least one of a first PSSCH, a first PSCCH, and the automatic gain control AGC symbol.

In some embodiments, the first terminal accesses a sidelink channel with a first priority class, a channel access priority class of data transmitted by the first terminal within a COT is higher than or equal to the first priority class, and the COT includes a COT initiated by the first terminal and the shared COT initiated by the second terminal.

In some embodiments, the first PSSCH is located within a COT in which the second PSSCH or the first PSFCH is located, and the COT includes a COT initiated by the first terminal and the shared COT initiated by the second terminal.

In some embodiments, a time gap between the start time of the first PSSCH and the end time of the second PSSCH or first PSFCH is D, and a length of the first signal is greater than or equal to D−Y, where Y is the first time threshold.

In some embodiments, in a case that the first signal is transmitted before the start time of the first transmission resource, the first signal includes at least one of the following:
a cyclic prefix CP extension for the first PSSCH;
a CP extension for an automatic gain control AGC symbol of the first PSSCH;
at least part of a specific symbol of the first PSSCH; and
a specific pilot signal.

In some embodiments, in a case that the first signal is transmitted after the end time of the second PSSCH or first PSFCH, the first signal includes at least one of the following:
an AGC symbol of the second PSSCH;
at least part of a specific symbol of the second PSSCH; and
a specific pilot signal.

In some embodiments, in a case that the first terminal accesses the channel using Type 2A LBT and a subcarrier spacing is 60 KHz, the processor 710 is configured to perform a puncturing operation in the first A microseconds of the first PSFCH symbol following a gap symbol, and transmit the last B microseconds of the first PSFCH symbol, where a length of the first PSFCH symbol is A+B microseconds, and A and B are positive integers.

In some embodiments, the processor 710 is configured to perform channel listening in the gap symbol before the first PSFCH symbol and the first A microseconds of the first PSFCH symbol.

In some embodiments, the number of gap symbols is configured by a network-side device, preconfigured, or agreed by a protocol.

In some embodiments, the number of gap symbols is related to the SCS.

In some embodiments, in a case that the first terminal accesses the channel using the highest channel access priority class of Type 1 LBT for the PSFCH transmission, the processor 710 is configured to share a COT of the first terminal with a third terminal, such that the third terminal transmits at least one of the following within the COT of the first terminal: the PSCCH, the PSSCH, the PSFCH, and the AGC symbol, where a channel access priority class of the PSSCH is the highest priority class.

In some embodiments, the processor 710 is further configured to obtain information of the shared COT initiated by the second terminal, where a start time and end time of the shared COT are determined by a PSFCH period and/or a channel access priority class indicated in sidelink control information SCI.

In some embodiments, the processor 710 is further configured to obtain a duration of the shared COT initiated by the second terminal, where the duration of the shared COT is indicated by a specific sequence or signal transmitted by the second terminal in the gap of a symbol.

In some embodiments, a duration shared by the first terminal of the COT of the second terminal is determined by a value of a COT duration field in first SCI received by the first terminal from a second terminal side.

In some embodiments, in a case that the first terminal shares the COT initiated by the second terminal, a value of a COT duration field in second SCI transmitted by the first terminal is 0 or an invalid value.

In some embodiments, resources of the COT initiated by the second terminal shared by the first terminal are indicated by a resource selection window location Resource selection window location field in SCI 2-C;
or
the resources of the COT initiated by the second terminal shared by the first terminal are jointly indicated by a resource combinations Resource combinations field, a first resource location First resource location field, a reference slot location Reference slot location field, and a number of subchannels Number of subchannels field in the SCI 2-C.

In some embodiments, in a case that a PSFCH occasion is present between consecutive slots consecutive slots in absolute time, the processor 710 transmits the first signal in a PSFCH symbol, where the first signal includes a virtual PSFCH.

An embodiment of this application further provides a readable storage medium. The readable storage medium stores a program or instruction, and when the program or instruction is executed by a processor, the processes of the foregoing channel transmission method embodiments are implemented, with the same technical effects achieved. To avoid repetition, details are not described herein again.

The processor is a processor in the terminal in the foregoing embodiments. The readable storage medium includes a computer-readable storage medium, for example, a computer read-only memory ROM, a random access memory RAM, a magnetic disk, or an optical disc.

An embodiment of this application further provides a chip, where the chip includes a processor and a communication interface, the communication interface is coupled to the processor, and the processor is configured to run a program or instruction to implement the processes of the foregoing channel transmission method embodiments, with the same technical effects achieved. To avoid repetition, details are not described herein again.

It should be understood that the chip mentioned in this embodiment of this application may also be referred to as a system-level chip, a system chip, a chip system, a system-on-chip, or the like.

An embodiment of this application further provides a computer program or program product, where the computer program or program product is stored in a storage medium, and the computer program or program product is executed by at least one processor to implement the processes of the foregoing channel transmission method embodiments, with the same technical effects achieved. To avoid repetition, details are not described herein again.

An embodiment of this application further provides a sidelink transmission system including a terminal, where the terminal may be configured to perform the steps of the foregoing channel transmission method.

It should be noted that in the specification, the terms “include”, “comprise”, or any of their variants are intended to cover a non-exclusive inclusion, such that a process, method, article, or apparatus that includes a series of elements includes not only those elements but also other elements that are not expressly listed, or further includes elements inherent to such process, method, article, or apparatus. Without more restrictions, an element preceded by the statement “includes a . . . ” does not preclude the presence of other identical elements in the process, method, article, or apparatus that includes the element. In addition, it should be noted that the scope of the method and apparatus in the embodiments of this application is not limited to functions being performed in the order shown or discussed, but may further include functions being performed at substantially the same time or in a reverse order, depending on the functions involved. For example, the described method may be performed in an order different from the order described, and steps may be added, omitted, or combined. In addition, features described with reference to some examples may be combined in other examples.

Based on the foregoing description of the embodiments, persons skilled in the art can clearly understand that the method in the foregoing embodiments may be implemented through software on a necessary general hardware platform or certainly through hardware only, but in many cases, the former is the more preferred implementation. Based on such understanding, the technical solutions of this application essentially or the part thereof that contributes to the related art may be implemented in a form of a computer software product. The computer software product is stored in a storage medium (for example, ROM/RAM, a magnetic disk, or an optical disc), and includes several instructions for instructing a terminal (which may be a mobile phone, a computer, a server, an air conditioner, a network device, or the like) to perform the method described in the embodiments of this application.

The foregoing describes the embodiments of this application with reference to the accompanying drawings. However, this application is not limited to the foregoing specific embodiments. These specific embodiments are merely illustrative rather than restrictive. Inspired by this application, persons of ordinary skill in the art may develop many other forms without departing from the essence of this application and the protection scope of the claims, and all such forms fall within the protection scope of this application.

What is claimed is:

1. A channel transmission method, comprising:
obtaining, by a first terminal, resource information for sidelink transmission on an unlicensed band; and
performing the sidelink transmission by using a first mode based on the resource information; wherein the first mode comprises at least one of the following:
performing the sidelink transmission on multiple sidelink transmission resources, wherein a first signal is filled between two of the multiple sidelink transmission resources, such that a gap between the two sidelink transmission resources is less than or equal to a first time threshold; or
determining a channel occupancy time (COT) initiated by a second terminal, and performing the sidelink transmission by sharing the COT initiated by the second terminal; wherein
the sidelink transmission resource comprises at least one of the following: a physical sidelink shared channel (PSSCH), a PSFCH, a physical sidelink control channel (PSCCH), or an automatic gain control (AGC) symbol.

2. The method according to claim 1, wherein the method further comprises:
transmitting the first signal before a start time of a first transmission resource, wherein the first transmission resource comprises at least one of a first PSSCH, a first PSCCH, or the automatic gain control (AGC) symbol; and/or
transmitting the first signal after an end time of a second PSSCH or first PSFCH;
wherein the two sidelink transmission resources are adjacent, and the two sidelink transmission resources comprise the first transmission resource and the second PSSCH or first PSFCH before the first transmission resource.

3. The method according to claim 2, wherein the first terminal accesses a sidelink channel with a first priority class, a channel access priority class of data transmitted by the first terminal within a COT is higher than or equal to the first priority class, and the COT comprises a COT initiated by the first terminal and the shared COT initiated by the second terminal.

4. The method according to claim 2, wherein the first PSSCH is located within a COT in which the second PSSCH or the first PSFCH is located, and the COT comprises a COT initiated by the first terminal and the shared COT initiated by the second terminal.

5. The method according to claim 2, wherein a time gap between the start time of the first PSSCH and the end time of the second PSSCH or first PSFCH is D, and a length of the first signal is greater than or equal to D−Y, wherein Y is the first time threshold.

6. The method according to claim 2, wherein the first signal comprises at least one of the following:
a cyclic prefix (CP) extension;
a CP extension for an automatic gain control (AGC) symbol;
at least part of a specific symbol of the PSSCH; or
a specific pilot signal.

7. The method according to claim 1, wherein the method further comprises:
obtaining information of the shared COT initiated by the second terminal, wherein a start time and end time of the shared COT are determined by a PSFCH period and/or a channel access priority class indicated in sidelink control information (SCI).

8. The method according to claim 1, wherein the method further comprises:
not sharing, by the first terminal, the COT of the second terminal when a value of a COT duration field in first SCI received from a second terminal side is 0 or an invalid value.

9. The method according to claim 1, wherein a duration shared by the first terminal of the COT of the second terminal is determined by a value of a COT duration field in first SCI received by the first terminal from a second terminal side.

10. The method according to claim 1, wherein in a case that the first terminal shares the COT initiated by the second terminal, a value of a COT duration field in second SCI transmitted by the first terminal is 0 or an invalid value.

11. The method according to claim 1, wherein resources of the COT initiated by the second terminal shared by the first terminal are indicated by a resource selection window location Resource selection window location field in SCI 2-C;
or
the resources of the COT initiated by the second terminal shared by the first terminal are jointly indicated by a resource combinations Resource combinations field, a first resource location First resource location field, a reference slot location Reference slot location field, and a number of subchannels Number of subchannels field in the SCI 2-C.

12. A terminal, comprising a processor and a memory, wherein the memory stores a program or instruction capable of running on the processor, wherein the program or instruction, when executed by the processor, causes the terminal to perform:
obtaining resource information for sidelink transmission on an unlicensed band; and
performing the sidelink transmission by using a first mode based on the resource information; wherein the first mode comprises at least one of the following:
performing the sidelink transmission on multiple sidelink transmission resources, wherein a first signal is filled between two of the multiple sidelink transmission resources, such that a gap between the two sidelink transmission resources is less than or equal to a first time threshold; or
determining a channel occupancy time (COT) initiated by a second terminal, and performing the sidelink transmission by sharing the COT initiated by the second terminal; wherein
the sidelink transmission resource comprises at least one of the following: a physical sidelink shared channel (PSSCH), a PSFCH, a physical sidelink control channel (PSCCH), or an automatic gain control (AGC) symbol.

13. The terminal according to claim 12, wherein the program or instruction, when executed by the processor, causes the terminal to further perform:
transmitting the first signal before a start time of a first transmission resource, wherein the first transmission resource comprises at least one of a first PSSCH, a first PSCCH, or the automatic gain control (AGC) symbol; and/or
transmitting the first signal after an end time of a second PSSCH or first PSFCH;
wherein the two sidelink transmission resources are adjacent, and the two sidelink transmission resources comprise the first transmission resource and the second PSSCH or first PSFCH before the first transmission resource.

14. The terminal according to claim 13, wherein the first terminal accesses a sidelink channel with a first priority class, a channel access priority class of data transmitted by the first terminal within a COT is higher than or equal to the first priority class, and the COT comprises a COT initiated by the first terminal and the shared COT initiated by the second terminal.

15. The terminal according to claim 13, wherein a time gap between the start time of the first PSSCH and the end time of the second PSSCH or first PSFCH is D, and a length of the first signal is greater than or equal to D−Y, wherein Y is the first time threshold.

16. The terminal according to claim 12, wherein the first signal comprises at least one of the following:
a cyclic prefix (CP) extension;
a CP extension for an automatic gain control (AGC) symbol;
at least part of a specific symbol of the PSSCH; or
a specific pilot signal.

17. The terminal according to claim 12, wherein executed by the processor, causes the terminal to perform:
not sharing the COT of the second terminal when a value of a COT duration field in first SCI received from a second terminal side is 0 or an invalid value.

18. The terminal according to claim 12, wherein a duration shared by the first terminal of the COT of the second terminal is determined by a value of a COT duration field in first SCI received by the first terminal from a second terminal side.

19. The terminal according to claim 12, wherein in a case that the first terminal shares the COT initiated by the second terminal, a value of a COT duration field in second SCI transmitted by the first terminal is 0 or an invalid value.

20. A non-transitory readable storage medium, wherein the non-transitory readable storage medium stores a program or instruction, wherein the program or instruction, when executed by a processor, causes the processor to perform:
obtaining resource information for sidelink transmission on an unlicensed band; and
performing the sidelink transmission by using a first mode based on the resource information; wherein the first mode comprises at least one of the following:
performing the sidelink transmission on multiple sidelink transmission resources, wherein a first signal is filled between two of the multiple sidelink transmission resources, such that a gap between the two sidelink transmission resources is less than or equal to a first time threshold; or
determining a channel occupancy time (COT) initiated by a second terminal, and performing the sidelink transmission by sharing the COT initiated by the second terminal; wherein
the sidelink transmission resource comprises at least one of the following: a physical sidelink shared channel (PSSCH), a PSFCH, a physical sidelink control channel (PSCCH), or an automatic gain control (AGC) symbol.
